(19) United States
(12) Patent Application Publication
(10) Pub. No.: US 2009/0135103 A1
(43) Pub. Date: May 28, 2009

(54) ORGANIC LIGHT EMITTING DEVICE

(76) Inventor: Changnam Kim, Seoul (KR)

Correspondence Address: KED & ASSOCIATES, LLP, P.O. Box 221200, Chantilly, VA, 20153-1200, US

(21) Appl. No.: 11/950,043

(22) Filed: Dec. 4, 2007

(30) Foreign Application Priority Data
Nov. 27, 2007 (KR) 10-2007-0121536

(51) Int. Cl. G09G 3/30

(52) U.S. Cl. 345/76

(57) ABSTRACT

An organic light emitting device includes a substrate having a plurality of pixels, with each pixel comprising a plurality of sub-pixels. Each sub-pixel includes an emission area that contains a first electrode, a second electrode, and an emitting layer. The emitting layer of at least one sub-pixel includes a phosphorescence material. In addition to these features, the device includes a scan line to provide a scan signal to a corresponding sub-pixel, a data line to supply data signal to a corresponding sub-pixel, and a power supply line configured to provide power to a corresponding sub-pixel. The resistance of the data line is lower than a resistance of the scan line.

This application claims the benefit of Korean Patent Application No. 10-2007-0121536 filed Nov. 27, 2007, the subject matters of which are incorporated herein by reference.

### BACKGROUND

1. Field

One or more embodiments described herein relate to a display device.

2. Background

The importance of flat panel displays has recently increased with consumer demand for multimedia products and services. One type of flat panel display known as an organic light emitting device (OLED) is desirable because of its rapid response time, low power consumption, self-emitting structure, and wide viewing angle. In spite of these advantages, OLEDs are generally unable to achieve uniform luminance which makes them unreliable.

### BRIEF DESCRIPTION OF THE DRAWINGS

FIG. 1 is a plane view of one embodiment of an organic light emitting device.

FIGS. 2A and 2B are cross-sectional views taken along a line I-I′ of FIG. 1.

FIG. 3 is a cross-sectional view of another embodiment of an organic light emitting device.

FIGS. 4A to 4C illustrate various implementations of a color image display method in an organic light emitting device according to one or more exemplary embodiments described herein.

### DETAILED DESCRIPTION

An organic light emitting device may be driven using different methods. In an OLED driven by a passive-matrix method, an anode electrode is set at right angles to a cathode electrode and the panel is driven by the selection of lines. In an OLED driven by an active-matrix method, a thin film transistor is connected to each pixel electrode and the panel is driven based on the capacitance of a capacitor connected to a gate electrode of the thin film transistor.

One specific type of active-matrix OLED supplies a scan signal and a data signal to each pixel through respective scan and data lines. Light is then emitted when electrical power is supplied to each pixel through a power supply line. However, because the scan, data, and power supply lines are formed of a metal which has electrical resistance characteristics, a signal supplied to a pixel far away from a supply source is distorted by the resistance of each line. Accordingly, the luminance of the organic light emitting device is not uniform and reliability is reduced.

According to one embodiment, an organic light emitting device includes a substrate having a plurality of pixels. Each pixel is formed from a plurality of sub-pixels, and each sub-pixel includes an emission area that has a first electrode, a second electrode and an emitting layer. The emitting layer of at least one sub-pixel includes a phosphorescence material.

The device further includes a plurality of scan lines, data lines, and power supply lines. The scan lines are configured to provide scan signals to corresponding sub-pixels, the data lines are configured to supply data signals to corresponding sub-pixels, and the power supply lines are configured to provide power to one or more corresponding sub-pixels.

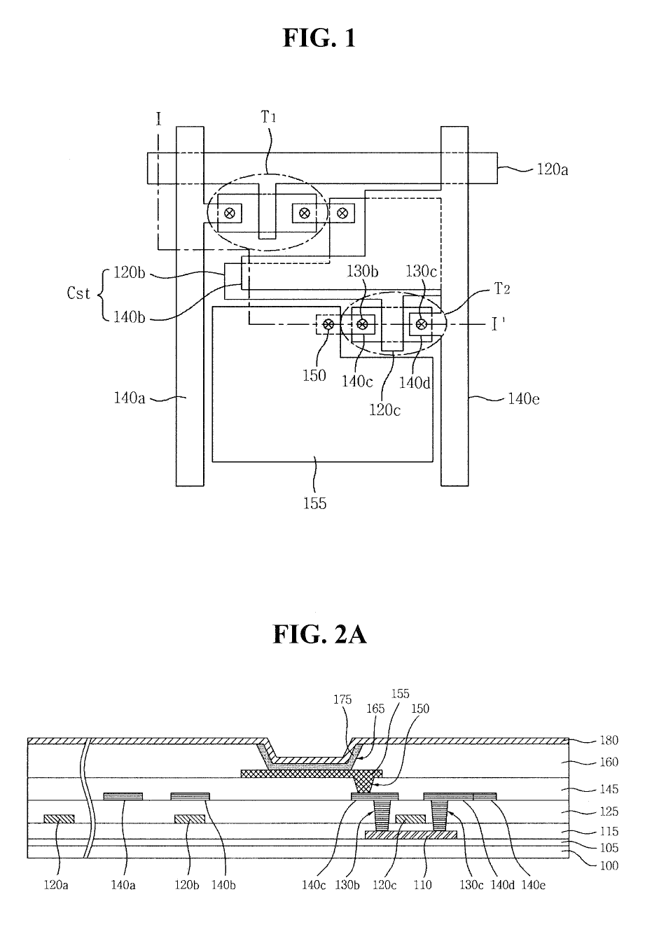

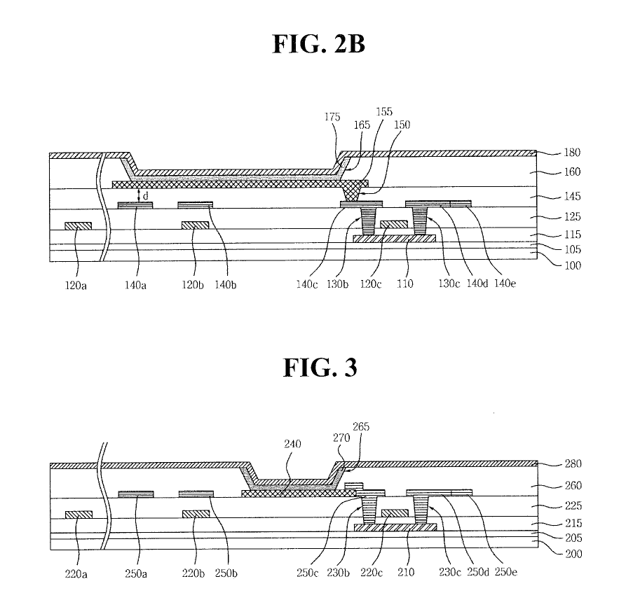

FIGS. 1, 2A, and 2B show one embodiment of a structure of a sub-pixel of the aforementioned organic light emitting device. This structure includes a substrate 100 having a plurality of sub-pixel and non-sub-pixel areas. As shown, for example, in FIG. 1, a sub-pixel and a non-sub-pixel area may be defined by a scan line 120a that extends in one direction, a data line 140a that extends substantially perpendicular to scan line 120a, and a power supply line 140e positioned parallel to data line 140a.

The sub-pixel area may include a switching thin film transistor T1 connected to scan line 120a and data line 140a, a capacitor Cst connected to the switching thin film transistor T1 and the power supply line 140e, and a driving thin film transistor T2 connected to the capacitor Cst and the power supply line are positioned in the pixel area. The capacitor Cst may include a capacitor lower electrode 120b and a capacitor upper electrode 140b.

The sub-pixel area may also include an organic light emitting diode, which includes a first electrode 155 electrically connected to the driving thin film transistor T2, an emitting layer (not shown) positioned on the first electrode 155, and a second electrode (not shown). The scan line 120a, data line 140a, and power supply line 140e are positioned in the non-sub-pixel area.

FIGS. 2A and 2B are a cross-sectional view taken along a line I-I′ of FIG. 1. As shown, a buffer layer 105 is positioned on the substrate 100. The buffer layer prevents impurities (e.g., alkali ions discharged from the substrate) from being introduced during formation of the thin film transistor in a succeeding process. The buffer layer may be selectively formed using silicon oxide (SiO2) and silicon nitride (SiNX), or using other materials, and the substrate may be formed of glass, plastic, or metal.

A semiconductor layer 110 is positioned on the buffer layer 105 and may be formed from amorphous silicon or crystallized poly-silicon. The semiconductor layer includes a source area and a drain area including p-type or n-type impurities, as well as a channel area.

A first insulating layer 115, which may be a gate insulating layer, is positioned on semiconductor layer 110 and may be formed from a silicon oxide (SiO2) layer, a silicon nitride (SiNX) layer, or a multi-layered structure or a combination thereof.

A gate electrode 120c is positioned on the first insulating layer 115 in a given area of the semiconductor layer 110, e.g., in a location corresponding to the channel area of the semiconductor layer when impurities are doped. The scan line 120a and the capacitor lower electrode 120b may be positioned on the same formation layer as the gate electrode 120c.

The gate electrode 120c may be formed of molybdenum (Mo), aluminum (Al), chromium (Cr), gold (Au), titanium Ti), nickel (Ni), neodymium (Nd), or copper (Cu), or a combination thereof. In accordance with one embodiment, the gate electrode may have a multi-layered structure formed of Mo, Al, Cr, Au, Ti, Ni, Nd, or Cu, or a combination thereof. In accordance with another embodiment, the gate electrode may have a double-layer structure including Mo/Al—Nd or Mo/Al.

The scan line 120a may be formed of Mo, Al, Cr, Au, Ti, Ni, Nd, or Cu, or a combination thereof. In accordance with one embodiment, the scan line may have a multi-layered structure formed of Mo, Al, Cr, Au, Ti, Ni, Nd, or Cu, or a combination thereof. In accordance with another embodiment, the scan line may have a double-layer structure including Mo/Al—Nd or Mo/Al.

According to one embodiment, the scan line 120a may have a width equal to or more than 3 μm and less than 5 μm and a thickness equal to or more than 300 nm and less than 450 nm. In alternative embodiments, the scan line may have different widths or thicknesses. In operation, the scan line 120a supplies a scan signal to one or more corresponding sub-pixels; that is, a scan driver positioned outside the pixel area supplies a scan signal to each pixel through one or more corresponding scan lines.

Because the scan line 120a is a metal conductive line having electrical resistance characteristics, a value of a scan signal supplied to a pixel near the scan driver may be different from a value of a scan signal supplied to a pixel far away from the scan driver. More specifically, since the scan driver supplies a scan signal to a corresponding sub-pixel through scan line 120a, the scan signal may have a different value due to a resistance of the scan line 120a. This may be attributable to a voltage drop (IR-drop) caused by the resistance of the scan line 120a.

In accordance with one embodiment, a thickness and/or a width of scan line 120a is adjusted to reduce the resistance of the scan line 120a, to thereby prevent or reduce the chances of a voltage drop from occurring.

Accordingly, scan line 120a may have a predetermined width and/or thickness to control resistance along the length of the line. This resistance may be controlled relative to a resistance of the data line, another line or element in the device, or another criteria. According to one non-limiting embodiment, scan line 120a may have a width equal to or more than 3 μm and less than 5 μm and a thickness equal to or more than 300 nm and less than 450 nm.

When the width of the scan line 120a is equal to or more than 3 μm, the resistance of the scan line 120a may be reduced or minimized and thus a voltage drop can be prevented, e.g., values of scan signals supplied to corresponding sub-pixels may be substantially the same irrespective of how far away the pixels are positioned from the scan driver. Hence, non-uniformity of the luminance of the organic light emitting device can be prevented. When the width of the scan line 120a is less than 5 μm, pixel shrinkage can also be prevented due to an increase in the width of the scan line 120a.

When the thickness of the scan line 120a is equal to or more than 300 nm, the resistance of the scan line 120a is reduced or minimized, and thus the voltage drop can be prevented. Hence, non-uniformity of luminance of the device can be prevented. When the thickness of the scan line 120a is less than 450 nm, step coverage of layers such as an insulating layer to be formed later can be reduced. Hence, exposure of the scan line 120a can be prevented, which, in turn, reduces the chances of a short forming between the scan line 120a and another conductive line.

A second insulating layer 125, which may be an interlayer dielectric, is positioned on substrate 100 on which scan line 120a, capacitor lower electrode 120b, and gate electrode 120c are positioned. The second insulating layer 125 may include a silicon oxide (SiO2) layer, a silicon nitride (SiNX) layer, or a multi-layered structure including a combination thereof.

Contact holes 130b and 130c are positioned inside the second insulating layer 125 and the first insulating layer 115 to expose a portion of the semiconductor layer 120.

A drain electrode 140c and a source electrode 140d are positioned in the pixel area to be electrically connected to the semiconductor layer 120 through the contact holes 130b and 130c passing through the second insulating layer 125 and the first insulating layer 115.

The drain electrode 140c and the source electrode 140d may have a single-layer or multi-layer structure. When the drain electrode 140c and source electrode 140d have a single-layer structure, each of the drain electrode and source electrode may be made of Mo, Al, Cr, Au, Ti, Ni, Nd, or Cu, or a combination thereof.

When drain electrode 140c and source electrode 140d have a multi-layer structure, each of the drain electrode and source electrode may have a double-layer structure including Mo/Al—Nd or a triple-layer structure including Mo/Al/Mo or Mo/Al—Nd/Mo.

The data line 140a, capacitor upper electrode 140b, and power supply line 140e may be positioned on the same formation layer as the drain electrode 140c and the source electrode 140d.

The data line 140a and power supply line 140e in the non-sub-pixel area may have a single-layer or multi-layer structure. When the data line and power supply line have a single-layer structure, the data line and power supply line may be made of Mo, Al, Cr, Au, Ti, Ni, Nd, or Cu, or a combination thereof.

When the data line and power supply line have a multi-layer structure, the data line and power supply line may have a double-layer structure including Mo/Al—Nd or a triple-layer structure including Mo/Al/Mo or Mo/Al—Nd/Mo. In one embodiment, data line 140a and power supply line 140e may have a triple-layer structure including Mo/Al—Nd/Mo. Additionally, the double-layer structure may be made of Ti/AL, or the triple-layer structure may be made of Ti/Al/Ti.

According to another embodiment, data line 140a may have a width of 3 μm to 5 μm and a thickness of 450 to 600 nm. In operation, the data line supplies a data signal to one or more corresponding sub-pixels; that is, a data driver positioned outside the sub-pixel area supplies a data signal to a predetermined number of sub-pixels.

Because data line 140a is a metal conductive line having electrical resistance characteristics, a value of a data signal supplied to a sub-pixel near the data driver may be different from a value of a data signal supplied to a sub-pixel far away from the data driver. More specifically, since the data driver supplies a data signal to one or more corresponding sub-pixels through data line 140a, the data signal of each sub-pixel may have a different value due to a resistance of the data line. This, in turn, may cause a voltage drop (IR-drop) to occur as a result of the resistance of the data line.

According to one embodiment, a thickness and/or width of the data line may be adjusted to reduce the resistance of the data line and thus the voltage drop is prevented. More specifically, data line 140a may have a predetermined width and/or thickness set to control resistance along the length of the line. This resistance may be controlled relative to the resistance of the data line or power supply line, another line or element in the device, or another criteria.

According to one non-limiting embodiment, data line 140a may have a width of 3 to 5 μm and a thickness of 450 to 600 nm. When the width of the data line is equal to or more than 3 μm, the resistance of the data line may be reduced or minimized and thus voltage drop can be prevented, e.g., the values of the data signals supplied to one or more sub-pixels may be substantially the same irrespective of how far away the sub-pixels are positioned from the data driver. When the width of the data line is equal to or less than 5 μm, pixel shrinkage can also be prevented due to an increase in the width of the data line.

When the thickness of the data line 140a is equal to or more than 450 nm, the resistance of the data line is reduced or minimized and thus the voltage drop can be prevented. When the thickness of the data line 140a is equal to or less than 600 nm, step coverage of layers (such as an insulating layer to be formed later) can be reduced. Hence, exposure of the data line can be prevented, which, in term, prevents a short from forming between data line 140a and another conductive line.

According to one embodiment, power supply line 140e may have a width of 5 to 7 μm and a thickness of 450 to 600 nm. The power supply line 140e is used to supply electrical power to one or more corresponding sub-pixels.

Because the power supply line 140e is a metal conductive line which has electrical resistance characteristics, electrical power supplied to a sub-pixel near a power supply unit (not shown) may be different from electrical power supplied to a pixel far away from the power supply unit. More specifically, since the power supply unit supplies electrical power to one or more corresponding sub-pixels through power supply line 140e, electrical power supplied to each sub-pixel may have different values due to resistance of the power supply line. Consequently, a voltage drop (IR-drop) may occur as a result of the resistance of the power supply line.

In accordance with one embodiment, a thickness and/or a width of the power supply line 140e is adjusted to reduce the resistance of the power supply line, to thereby prevent or reduce the chances of a voltage drop from occurring.

That is, power supply line 140e may have a predetermined width and/or thickness set to control resistance along the length of the line. This resistance may be controlled relative to a resistance of the data or scan lines, another line or element in the device, or another criteria. According to one non-limiting embodiment, the power supply line may have a width of 5 to 7 μm and a thickness of 450 to 600 nm.

When the width of the power supply line 1 is equal to or more than 5 μm, resistance of the power supply line 140e is reduced or minimized and thus non-uniformity of a luminance in the panel caused by voltage drop can be prevented, e.g., values of electrical power supplied to sub-pixels connected to the line may be substantially the same irrespective of how far away the sub-pixels are positioned from the power supply unit. When the width of the power supply line is equal to or less than 7 μm, pixel shrinkage can also be prevented due to an increase in the width of the power supply line.

When the thickness of power supply line 140e is equal to or more than 450 nm, resistance of the power supply line is reduced or minimized and thus non-uniformity of luminance the panel caused by voltage drop can be prevented. When the thickness of the power supply line is equal to or less than 600 nm, step coverage of layers (such as an insulating layer to be formed later) can be reduced. Hence, exposure of the power supply line 140e can be prevented, to thereby prevent or reduce the chances of a short forming between the power supply line and another conductive line.

In particular, when the data line and power supply line have a triple-layer structure including Mo/Al/Mo or Mo/Al—Nd/Mo, a thickness of a first layer may range from 40 to 60 nm, a thickness of a second layer may range from 400 to 500 nm, and a thickness of a third layer may range from 10 to 30 nm.

In the triple-layer structure, a Mo layer forming the first layer serves as an ohmic contact to reduce a resistance between the Mo layer and another layer, and a thickness of the Mo layer may range from 40 to 60 nm. An Al or Al—Nd layer forming the second layer has a low resistance and reduces the resistances of the lines, and a thickness of the Al or Al—Nd layer may range from 400 to 500 nm. A Mo layer forming the third layer servers as a protective layer for avoiding an Al or Al—Nd hillock phenomenon, in which Al or Al—Nd rises at a high temperature, in a succeeding thermal process. A thickness of the Mo layer may range from 10 to 30 nm.

According to any one or more of the foregoing embodiments, the widths and/or thicknesses of lines 120a, 140a and 140e can be adjusted to reduce the resistances of the data line 140a and the power supply line 140e.

A resistance of the data line 140a may be set to be lower than a resistance of the scan line 120a. To accomplish this, the thickness of data line 140a may be set to be larger than the thickness of the scan line 120a and/or the width of the data line 140a may be set to be larger than the width of the scan line 120a. Hence, a cross-sectional area of the data line 140a, determined by thickness and/or width, may be larger than a cross-sectional area of the scan line 120a.

From an operational standpoint, the data line 140a and scan line 120a send a data signal and a scan signal to each sub-pixel, respectively. While the scan signal is used to turn on or off the switching thin film transistor T1, the data signal is sent to the driving thin film transistor T2 driving the light emitting diode. In other words, because the data signal directly affects luminance, the data signal may be more sensitive than the scan signal to the line resistance.

Accordingly, the resistance of data line 140a can be set to be lower than the resistance of the scan line 120a, by forming the cross-sectional area of the data line 140a to be larger than the cross-sectional area of the scan line 120a.

A resistance of the power supply line 140e may be lower than a resistance of the data line 140a, e.g., the width of the power supply line 140e may be larger than the width of the data line 140a. Hence, a cross-sectional area of the power supply line 140e determined by the width may be formed to be larger than a cross-sectional area of the data line 140a.

While the data line 140a sends the data signal to each pixel, current does not flow into the data line 140a in a normal state. Therefore, the adverse affect of voltage drop on the data line 140a may be less than the adverse affect of the voltage drop on the power supply line 140e. However, because the power supply line is directly connected to the organic light emitting diode including the first electrode 155, emitting layer, and second electrode, the voltage drop of power supply line 140e directly affects non-uniformity of the luminance of the panel. The power supply line 140e is therefore very sensitive to the resistance.

Accordingly, the resistance of the power supply line 140e can be set to be lower than the resistance of the data line 140a, by forming the cross-sectional area of the power supply line 140e to be larger than the cross-sectional area of the data line 140a.

A third insulating layer 145 is positioned on the data line 140a, the capacitor upper electrode 104b, the drain electrode 140c, the source electrode 140d, and the power supply line 140e. The third insulating layer may be a planarization layer for obviating the height difference of a lower structure.

Also, the third insulating layer may be formed of an organic material such as polyimide, benzocyclobutene-based resin and acrylate or an inorganic material such as spin on glass (SOG) obtained by spin-coating silicone oxide (SiO2) in the liquid form and solidifying it. Otherwise, the third insulating layer 145 may be a passivation layer, and may include a silicon oxide (SiO2) layer, a silicon nitride (SiNX) layer, or a multi-layered structure including a combination thereof.

A via hole 150 is positioned inside the third insulating layer 145 to expose one of the source and drain electrodes 140c and 140d. The first electrode 155 is positioned on the third insulating layer 145 to be electrically connected to one of the source and drain electrodes 140c and 140d via the via hole.

The first electrode 155 may be an anode electrode which includes one or more of the following: a transparent electrode or a reflection electrode. For example, when the organic light emitting device has a bottom-emission or dual-emission structure, the first electrode may be a transparent electrode formed of one of indium-tin-oxide (ITO), indium-zinc-oxide (IZO) and zinc oxide (ZnO). When the organic light emitting device has a top-emission structure, the first electrode may be a reflection electrode. In this case, a reflection layer formed of Al, Ag, or Ni may be positioned under a layer formed of ITO, IZO, or ZnO, and also a reflection layer formed of Al, Ag, or Ni may be positioned between two layers formed of ITO, IZO, or ZnO.

FIG. 2B shows an organic light emitting device in which the first electrode 155 is formed up to an upper portion of the data line 140a. As illustrated in FIG. 2B, in case that the first electrode 155 is positioned on the upper portion of the data line 140a, a distance “d” between the first electrode 155 and the data line 140a may be in a predetermined range, e.g., from 1 to 7 μm.

When the distance d is equal to or more than a predetermined value, e.g., 1 μm, generation of parasitic capacitance can be reduced or prevented because the first electrode 155 is positioned closely to the data line 140a. When the via hole 150 electrically connected to the first electrode 155 and the drain electrode 140c is formed, the connection between the via hole 150 and the first electrode 155 deposited on an edge portion of the via hole 150 may be cut off due to an increase in an angle of the edge portion of the via hole 150. However, when the distance d is equal to or less than the predetermined value, e.g., 7 μm, cut-off of the connection can be prevented.

That is, for example, cut-off of the connection of the first electrode 155, which is deposited on an edge portion of the via hole 150 electrically connected to the first electrode 155 and the drain electrode 140c, can be prevented. Cut-off of the connection of the first electrode 155 may be caused by an increase in an angle of the edge portion of the via hole 150.

Referring again to FIG. 2A, a fourth insulating layer 160 including an opening 165 may be positioned on the first electrode 155. The opening 165 provides electrical insulation between neighboring first electrodes 155 and exposes a portion of the first electrode 155.

An emitting layer 175 may be positioned on the first electrode 155 exposed by opening 165. The emitting layer 175 may be formed of a material capable of emitting red, green, or blue light such as, for example, a phosphorescence material or a fluorescence material.

In case that the emitting layer 175 emits red light, the emitting layer includes a host material including carbazole biphenyl (CBP) or 1,3-bis(carbazol-9-yl (mCP), and may be formed of a phosphorescence material including a dopant material including any one selected from the group consisting of PIQIr(acac)(bis(1-phenylisoquinoline)acetylacetonate iridium), PQIr(acac)(bis(1-phenylquinohne)acetylacetonate iridium), PQIr(tris(1-phenylquinoline)iridium), or PtOEP(octaethylporphyrin platinum), or a fluorescence material including PBD:Eu(DBM)3(Phen) or Perylene.

In the case where emitting layer 175 emits red light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.0 to 6.0, and a lowest unoccupied molecular orbital of the dopant material may range from 2.4 to 3.5. In other embodiments, different ranges may be used.

In the case where emitting layer 175 emits green light, the emitting layer may include a host material including CBP or mCP, and/or may be formed of a phosphorescence material including a dopant material including Ir(ppy)3(fac tris(2-phenylpyridine)iridium) or a fluorescence material including Alq3(tris(8-hydroxyquinolino)aluminum). In other embodiments, different materials may be used.

In the case where emitting layer 175 emits green light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5. In other embodiments, different ranges may be used.

In the case where emitting layer 175 emits blue light, the emitting layer may include a host material including CBP or mCP, and/or may be formed of a phosphorescence material including a dopant material including (4,6-F2 ppy)2Irpic or a fluorescence material including any one selected from the group consisting of spiro-DPVBi, spiro-6P, distyryl-benzene (DSB), distyryl-arylene (DSA), PFO-based polymers, PPV-based polymers, or a combination thereof.

In the case where emitting layer 175 emits blue light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5. In other embodiments, different ranges may be used.

In embodiments where the emitting layer 175 emits red, green, or blue light and includes a phosphorescence material, light emitting efficiency can be increased and power voltage can be reduced.

A second electrode 180 is positioned on the emitting layer 175. The second electrode may be a cathode electrode and may be formed of Mg, Ca, Al, or Ag having a low work function or a combination thereof. When the organic light emitting device has a top emission or dual emission structure, the second electrode 180 may be thin to the extent that the second electrode 180 transmits light. When the organic light emitting device has a bottom emission structure, the second electrode 180 may be thick to the extent that the second electrode 180 reflects light.

The organic light emitting device according to an exemplary embodiment is manufactured using a total of 7 masks. The 7 masks may be used in a formation process of the semiconductor layer, a formation process of the gate electrode (including the scan line and the capacitor lower electrode), a formation process of the contact holes, a formation process of the source and drain electrodes (including the data line, the power supply line and the capacitor upper electrode), a formation process of the via holes, a formation process of the first electrode, and a formation process of the opening, respectively. An example of how an organic light emitting device is formed using a total of 5 masks will now be given.

FIG. 3 shows a cross-section of the structure of another embodiment of an organic light emitting device. Structures and components identical or equivalent to those described in exemplary embodiments are designated with the same reference numerals, and the description thereabout is briefly made or is entirely omitted.

As shown in FIG. 3, a buffer layer 205 is positioned on a substrate 200, a semiconductor layer 210 is positioned on the buffer layer, a first insulating layer 215 is positioned on the semiconductor layer, and a gate electrode 220c, a capacitor lower electrode 220b, and a scan line 220a are positioned on the first insulating layer 215. A second insulating layer 225 is positioned on the gate electrode 220c.

A first electrode 240 is positioned on the second insulating layer 225, and contact holes 230b and 230c are positioned to expose the semiconductor layer 210. The first electrode 240 and the contact holes 230b and 230c may be simultaneously formed.

A source electrode 250d, a drain electrode 250c, a data line 250a, a capacitor upper electrode 250b, and a power supply line 250e are positioned on the second insulating layer 225. A portion of the drain electrode 250c may be positioned on the first electrode 240.

A pixel, or sub-pixel, definition layer or a third insulating layer 260, which may be a bank layer, is positioned on the substrate 200 on which the above-described structure is formed. An opening 265 is positioned on the third insulating layer 260 to expose the first electrode 240. An emitting layer 270 is positioned on the first electrode 240 exposed by the opening 265, and a second electrode 280 is positioned on the emitting layer 270.

The aforementioned organic light emitting device can be manufactured using a total of five masks. More specifically, the five masks are used in a formation process of the semiconductor layer, a formation process of the gate electrode (including the scan line and the capacitor lower electrode), a formation process of the first electrode (including the contact holes), a formation process of the source and drain electrodes (including the data line, the power supply line and the capacitor upper electrode), and a formation process of the opening, respectively. Accordingly, the organic light emitting device according to another exemplary embodiment can reduce the manufacturing cost by a reduction in the number of masks and can improve the efficiency of mass production.

An organic light emitting device in accordance with any one of the embodiments described herein may have uniform luminance, achieved by setting the resistance of one or more of the scan, data, or power supply lines to be lower than a resistance of one or more of these other lines. By setting these resistances, reliability of the organic light emitting device can be improved. According to one non-limiting embodiment, the resistance of the data line is set to be lower than a resistance of the scan line.

In accordance with one embodiment, an organic light emitting device comprises a substrate including a sub-pixel area and a non-sub-pixel area, a scan line positioned in the non-sub-pixel area to supply a scan signal to the sub-pixel area, a data line positioned in the non-sub-pixel area to supply a data signal to the sub-pixel area, and a power supply line positioned in the non-sub-pixel area and to supply power to the sub-pixel area. In this structure, a resistance of the data line is lower than a resistance of the scan line.

In accordance with another embodiment, the an organic light emitting device may be formed based on the structure shown in FIGS. 1, 2A, and 2B, except that instead of sub-pixels the device is formed from a plurality of white pixels, e.g., the scan, data, and power supply lines define pixel and non-pixel areas.

For example, such an embodiment may therefore include a substrate having a plurality of white pixels, each pixel including an emission area having a first electrode, a second electrode and an emitting layer. The emitting layer of at least one pixel may include a phosphorescence material.

Additionally, the embodiment may include a plurality of scan lines configured to provide one or more scan signals to corresponding pixels, a plurality of data lines configured to supply one or more data signals to a corresponding pixel, and a plurality of power supply lines configured to provide power to one or more corresponding pixels. A resistance of the data line is lower than a resistance of the scan line.

Each white pixel may, for example, be used with one or more color filters in order to emit light of a desired color. The color filters may include red, green, and blue filters, the same array of filters in addition to an optical pathway for allowing white light to pass, or red, green and blue filters.

In accordance with embodiments described herein, the emitting layer may emit light of a certain color. In a case where the emitting layer emits red light, the emitting layer may include a host material including carbazole biphenyl (CBP) or 1,3-bis(carbazol-9-yl (mCP), and may be formed of a phosphorescence material including a dopant material including PIQIr(acac)(bis(1-phenylisoquinoline)acetylacetonate iridium), PQIr(acac)(bis(1-phenylquinoline)acetylacetonate iridium), PQlr(tris(1-phenylquinoline)iridium), or PtOEP(octaethylporphyrin platinum) or a fluorescence material including PBD:Eu(DBM)3(Phen) or Perylene.

In the case where the emitting layer emits red light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.0 to 6.0, and a lowest unoccupied molecular orbital of the dopant material may range from 2.4 to 3.5.

In the case where the emitting layer emits green light, the emitting layer includes a host material including CBP or mCP, and may be formed of a phosphorescence material including a dopant material including Ir(ppy)3(fac tris(2-phenylpyridine)iridium) or a fluorescence material including Alq3(tris(8-hydroxyquinolino)aluminum).

In the case where the emitting layer emits green light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5.

In the case where the emitting layer emits blue light, the emitting layer includes a host material including CBP or mCP, and may be formed of a phosphorescence material including a dopant material including (4,6-F2 ppy)2Irpic or a fluorescence material including spiro-DPVBi, spiro-6P, distyryl-benzene (DSB), distyryl-arylene (DSA), PFO-based polymers, PPV-based polymers, or a combination thereof.

In the case where the emitting layer emits blue light, a highest occupied molecular orbital of the host material may range from 5.0 to 6.5, and a lowest unoccupied molecular orbital of the host material may range from 2.0 to 3.5. A highest occupied molecular orbital of the dopant material may range from 4.5 to 6.0, and a lowest unoccupied molecular orbital of the dopant material may range from 2.0 to 3.5.

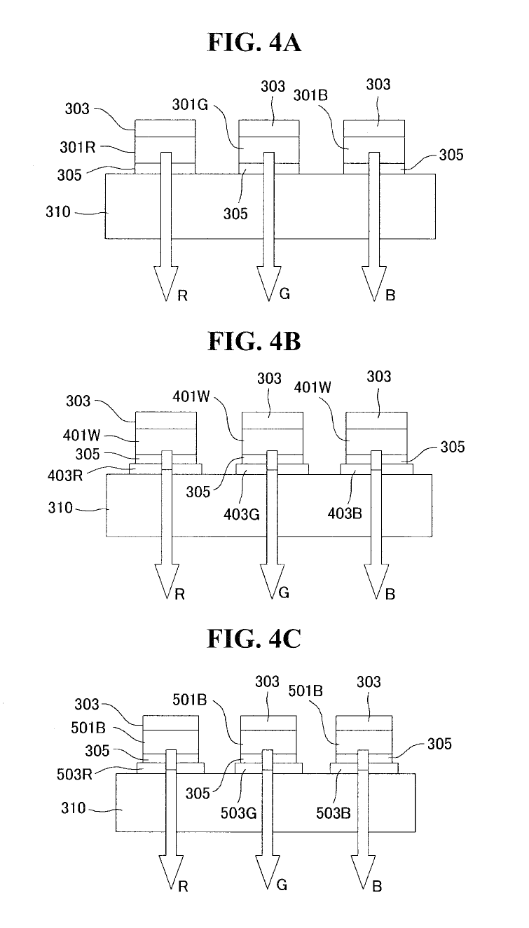

Various color image display methods may be implemented in an organic light emitting device such as described above. These methods will be described below with reference to FIGS. 4A to 4C.

FIGS. 4A to 4C illustrate various implementations of a color image display method in an organic light emitting device according to an exemplary embodiment of the present invention.

First, FIG. 4A illustrates a color image display method in an organic light emitting device separately including a red organic emitting layer 301R, a green organic emitting layer 301G and a blue organic emitting layer 301B which emit red, green and blue light, respectively.

The red, green and blue light produced by the red, green and blue organic emitting layers 301R, 301G and 301B is mixed to display a color image.

It may be understood in FIG. 4A that the red, green and blue organic emitting layers 301R, 301G and 301B each include an electron transporting layer, an emitting layer, a hole transporting layer, and the like. In FIG. 4A, a reference numeral 303 indicates a cathode electrode, 305 an anode electrode, and 310 a substrate. It is possible to variously change a disposition and a configuration of the cathode electrode, the anode electrode and the substrate.

FIG. 4B illustrates a color image display method in an organic light emitting device including a white organic emitting layer 401W, a red color filter 403R, a green color filter 403G and a blue color filter 403B. And the organic light emitting device further may include a white color filter (not shown).

As illustrated in FIG. 4B, the red color filter 403R, the green color filter 403G and the blue color filter 403B each transmit white light produced by the white organic emitting layer 401W to produce red light, green light and blue light. The red, green and blue light is mixed to display a color image.

It may be understood in FIG. 4B that the white organic emitting layer 401W includes an electron transporting layer, an emitting layer, a hole transporting layer, and the like.

FIG. 4C illustrates a color image display method in an organic light emitting device including a blue organic emitting layer 501B, a red color change medium 503R and a green color change medium 503G.

As illustrated in FIG. 4C, the red color change medium 503R and the green color change medium 503G each transmit blue light produced by the blue organic emitting layer 501B to produce red light, green light and blue light. The red, green and blue light is mixed to display a color image.

It may be understood in FIG. 4C that the blue organic emitting layer 501B includes an electron transporting layer, an emitting layer, a hole transporting layer, and the like.

A difference between driving voltages, e.g., the power voltages VDD and Vss of the organic light emitting device may change depending on the size of the display panel 100 and a driving manner. A magnitude of the driving voltage is shown in the following Tables 1 and 2. Table 1 indicates a driving voltage magnitude in case of a digital driving manner, and Table 2 indicates a driving voltage magnitude in case of an analog driving manner.

TABLE 1

| Size (S) of | | | | | | |
|---|---|---|---|---|---|---|
| display panel | VDD-Vss (R) | | VDD-Vss (G) | | VDD-Vss (B) | |
| S < 3 inches | 3.5-10 | (V) | 3.5-10 | (V) | 3.5-12 | (V) |
| 3 inches < S < | 5-15 | (V) | 5-15 | (V) | 5-20 | (V) |
| 20 inches | | | | | | |
| 20 inches < S | 5-20 | (V) | 5-20 | (V) | 5-25 | (V) |

TABLE 2

| Size (S) of display panel | VDD-Vss (R, G, B) |
|---|---|
| S < 3 inches | 4~20 (V) |
| 3 inches < S < 20 inches | 5~25 (V) |
| 20 inches < S | 5~30 (V) |

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

1. An organic light emitting device comprising:
a substrate having a plurality of pixels, each pixel comprising a plurality of sub-pixels, wherein each sub-pixel includes an emission area, the emission area including a first electrode, a second electrode and an emitting layer, the emitting layer of at least one sub-pixel includes a phosphorescence material;
a plurality of scan lines, a scan line configured to provide a scan signal to a corresponding sub-pixel;
a plurality of data lines, a data line configured to supply data signal to a corresponding sub-pixel;
a plurality of power supply lines, a power supply line configured to provide power to a corresponding sub-pixel, wherein a resistance of the data line is lower than a resistance of the scan line.

2. (canceled)

3. The organic light emitting device of claim 1, wherein each of the data line and the power supply line has a single-layered structure or a multi-layered structure.

4. The organic light emitting device of claim 3, wherein the single-layered structure includes molybdenum (Mo), aluminum (Al), chromium (Cr), gold (Au), titanium (Ti), nickel (Ni), neodymium (Nd), or copper (Cu).

5. The organic light emitting device of claim 3, wherein the multi-layered structure has a triple-layer structure including Mo/Al/Mo or Mo/Al-Nd/Mo.

6. The organic light emitting device of claim 1, wherein the scan line has a single-layered structure or a double-layered structure.

7. The organic light emitting device of claim 1, wherein a thickness of the data line is larger than a thickness of the scan line.

8. The organic light emitting device of claim 1, wherein a width of the data line is larger than a width of the scan line.

9. The organic light emitting device of claim 1, wherein a cross-sectional area of the data line is larger than a cross-sectional area of the scan line.

10. The organic light emitting device of claim 1, wherein a resistance of the power supply line is lower than a resistance of the data line.

11. The organic light emitting device of claim 1, wherein a width of the power supply line is larger than a width of the data line.

12. The organic light emitting device of claim 1, wherein a resistance of the power supply line is lower than a resistance of the scan line.

13. The organic light emitting device of claim 1, wherein a cross-sectional area of the power supply line is larger than a cross-sectional area of the data line.

14. The organic light emitting device of claim 1, wherein a distance between the data line and the first electrode lies substantially in a range between 1 to 7 μm.

15. The organic light emitting device of claim 1, wherein a width of the data line lies in range substantially between from 3 and 5 μm and a thickness of the data line lies in a range substantially between 450 nm and 600 nm.

16. The organic light emitting device of claim 1, wherein a width of the scan line lies in a range substantially between 3 and 5 μm and a thickness of the scan line lies in a range substantially between from 300 nm and 450 nm.

17. An organic light emitting device comprising:
a substrate having a plurality of pixels, each pixel comprising a plurality of sub-pixels, wherein each sub-pixel includes an emission area, the emission area including a first electrode, a second electrode and an emitting layer, the emitting layer of at least one sub-pixel includes a phosphorescence material;
a plurality of scan lines, a scan line configured to provide a scan signal to a corresponding sub-pixel;
a plurality of data lines, a data line configured to supply data signal to a corresponding sub-pixel;
a plurality of power supply lines, a power supply line configured to provide power to a corresponding sub-pixel, wherein a resistance of the data line is lower than a resistance of the scan line and wherein the scan line has a thickness in a first range and a width in a second range, and wherein the data line has a thickness in a third range and a width in a fourth range, the first range lies substantially between 300 nm and 450 nm, the second range lies substantially between 3 and 5 μm, the third range lies substantially between 450 nm to 600 nm, and the fourth range lies substantially between 3 and 5 μm

18. The organic light emitting device of claim 17, wherein the emitting layer of another sub-pixel includes a phosphorescence material.

19. (canceled)

20. The organic light emitting device of claim 17, wherein each of the data line and the power supply line has a multi-layered structure.

21. The organic light emitting device of claim 20, wherein the multi-layered structure has a triple-layer structure including Mo/Al/Mo or Mo/Al-Nd/Mo.

22. An organic light emitting device comprising:
a substrate having a plurality of pixels, each pixel including an emission area, the emission area including a first electrode, a second electrode and an emitting layer, the emitting layer of at least one pixel includes a phosphorescence material;
a plurality of scan lines, a scan line configured to provide a scan signal to a corresponding pixel;
a plurality of data lines, a data line configured to supply data signal to a corresponding pixel;
a plurality of power supply lines, a power supply line configured to provide power to a corresponding pixel, wherein a resistance of the data line is lower than a resistance of the scan line.

23. (canceled)
